(19) United States
(12) Patent Application Publication
(10) Pub. No.: US 2005/0240717 A1
(43) Pub. Date: Oct. 27, 2005

(54) Interleaved Mapping Method of Block-Index-To-SDRAM-Address for Optical Storage (CD/DVD) System

(75) Inventor: Kevin Lin, Taipei (TW)

Correspondence Address: SQUIRE, SANDERS & DEMPSEY L.L.P, 600 HANSEN WAY, PALO ALTO, CA, 94304-1043, US

(73) Assignee: VIA Technologies, Inc., Taipei (TW)

(21) Appl. No.: 10/709,296

(22) Filed: Apr. 27, 2004

(51) Int. Cl. G06F 12/00

(52) U.S. Cl. 711/5; 711/105

(57) ABSTRACT

A method for storing data into a SRDAM. The method comprises the following steps: receiving a plurality of blocks of data; labeling said blocks successively from 1 in step of 1; dividing the label of each of said blocks by M and acquiring a corresponding remainder for each of said block, wherein M is the number of banks in said SRDAM and a positive integer; and storing said blocks in said SRDAM in according to the following rule: any logical adjacent said blocks are located physically at different banks of said SRDAM. Herein, one said block has a remainder I is stored in the (I+1) bank in said SRDAM, I being a non-positive integer. Moreover, wherein a plurality of blocks in the same backs could be stored in sequence, and said blocks are arranged in the order of corresponding remainder.

### BACKGROUND OF THE INVENTION

1. Field of the Invention

Concurrently data buffering (bit-stream from servo subsystem), correcting (ECC & EDC) and transferring (to/from host computer or player) are the basic operations of a CD/DVD system. As the speed requirement goes higher and higher (e.g., 52× for CD or 16× for DVD, both read and write), the bandwidth of external buffer becomes much more critical than ever. The proposed invention introduces a new buffer layout for a compact disc (CD/DVD) controller, and it is very helpful to relieve bandwidth bottleneck of the external buffer in an ultra-high speed CD/DVD system.

2. Description of the Prior Art

In conventional method, external SDRAM buffer is partitioned into several blocks in unit of the same size to fit a CD/DVD ECC block (1 sector for CD-ROM or 16 sectors for DVD-ROM). Each block is pointed by an index i, with the next adjacent one pointing by index i+1. A ring buffer is constructed when block index i is constrained within 0˜(Imax−1), where Imax represents the maximum block number stored in buffer (See FIG. 1).

The pipeline operation in response to a disc read (decoding) command is done as following: Pipe (a) sequentially buffers incoming sectors into successive memory blocks i, i+1, i+2, . . . , and so on; Pipe (b) sequentially decodes blocks which are buffered in Pipe (a); Pipe (c) sequentially transfer corrected blocks to host of a PC or a player. Any block (sector) should go through Pipe (a)-Pipe (c) before reaching the host. Most bandwidth of external memory is occupied by Pipe (a)-Pipe (c) while decoding.

The pipeline operation in response to a disc write (recording) command is done as following: Pipe (a) sequentially receives user blocks from host and buffers them into successive memory blocks i, i+1, i+2, and so on; Pipe (b) sequentially encodes blocks which are buffered in Pipe (a); Pipe (c) sequentially writes encoded blocks to the target sector of a disc. Any block (sector) should go through Pipe (a)-Pipe (c) before being recorded onto the disc. Most bandwidth of external memory is occupied by Pipe (a)-Pipe (c) while recording.

Note that in read pipeline operation, Pipe (b), as a channel decoder, decodes a sector from streaming Pipe (a) once it is ready in buffer. They are most likely to be working over two sectors with adjacent indices. Moreover, in write pipeline operation, Pipe (b), as a channel encoder, encodes a sector from host Pipe (a) once it is ready in buffer. They are most likely to be working over two sectors with adjacent indices.

The conventional method is very straightforward since it uses sequential block addressing, provides a convenient way while mapping target sector (to or from disc) to physical address of SDRAM. However, during a read command, pipeline operations of Pipe (a) and Pipe (b) tend to access the same bank of the SDRAM buffer, since in most case Pipe (a) is just one sector ahead of Pipe (b). On the other hand, during a write command, pipeline operations of Pipe (a) and Pipe (b) tend to access the same (intra) bank of the SDRAM buffer, since in most case Pipe (a) is just one sector ahead of Pipe (b). For a standard SDRAM, ping-pong usage of inter-bank access is a great feature to reduce the overheads of SDRAM access. The conventional method leads to too much intra-bank-access of Pipe (a)-Pipe (b) during a disc read or writes operation and needs much pre-charge overheads between these intrabank-accesses. FIG. 2 shows an SDRAM access example that overheads occur.

For example, using a standard lMxl6 SDRAM we have 2 banks (upper or lower) each of 512K words. In conventional sequential method, Pipe (a) and Pipe (b) are always working over the same bank of the SDRAM buffer except when Pipe (a) has index at higher bank but Pipe (b) has its index at lower bank.

### SUMMARY OF THE INVENTION

The invention provides a method for storing data into a SRDAM. The method comprises the following steps: receiving a plurality of blocks of data; labeling said blocks successively from 1 in step of 1; dividing the label of each of said blocks by M and acquiring a corresponding remainder for each of said block, wherein M is the number of banks in said SRDAM and a positive integer; and storing said blocks in said SRDAM in according to the following rule: any logical adjacent said blocks are located physically at different banks of said SRDAM. Herein, one said block has a remainder I is stored in the (I+1) bank in said SRDAM, I being a non-positive integer. Moreover, wherein a plurality of blocks in the same backs could be stored in sequence, and said blocks are arranged in the order of corresponding remainder.

The invention also provides a system for storing data into a SRDAM. The system comprising: a receiver for receiving a plurality of blocks of data; a labeler for labeling said blocks successively from 1 in step of 1; a divider for dividing the label of each of said blocks by M and acquiring a corresponding remainder for each of said block, wherein M is the number of banks in said SRDAM and a positive integer; and an assigner for storing said blocks in said SRDAM in according to the following rule: any logical adjacent said blocks are located physically at different banks of said SRDAM. Herein, one said block has a remainder I is stored in the (I+1) bank in said SRDAM, I being a non-positive integer. Moreover, wherein a plurality of blocks in the same backs could be stored in sequence, and wherein said blocks could be arranged in the order of corresponding remainder.

The invention further provides a method of operating a disc player with a SRDAM. The method comprises: processing a plurality of blocks of data by performing a buffer pipe, a code pipe, and a transfer pipe in a specific order, wherein the steps of storing said blocks of data into said SRDAM comprising: labeling said blocks successively from 1 in step of 1; dividing the label of each of said blocks by M and acquiring a corresponding remainder for each of said block, wherein M is the number of banks in said SRDAM and a positive integer; and storing said blocks in said SRDAM in according to the following rule: any logical adjacent said blocks are located physically at different banks of said SRDAM. For one application, said buffer pipe is performed to receive said blocks before said code pipe is performed to decode said blocks, moreover, wherein said code pipe is performed before said transfer pipe is performed to transfer decoded block to a terminal. Herein, said terminal being chosen from the group consisting of the following: laptop, table personal computer, player, display, and combination thereof. For another application, said code pipe is performed after said transfer pipe is performed to transfer block from a terminal, moreover, wherein said buffer pipe is performed to output said blocks before said code pipe is performed to encode said blocks. Moreover, said terminal being chosen from the group consisting of the following: laptop, table personal computer, player, display, and combination thereof.

### BRIEF DESCRIPTION OF THE DRAWINGS

The foregoing aspects and many of the attendant advantages of the present invention will become more readily appreciated as the same becomes better understood by reference to the following detailed description, when taken in conjunction with the accompanying drawings, wherein:

FIG. 1. Example of Sequential Mapping Method for a 2-bank SDRAM Buffer;

FIG. 2. SDRAM Accesses Example in Sequential Mapping Method;

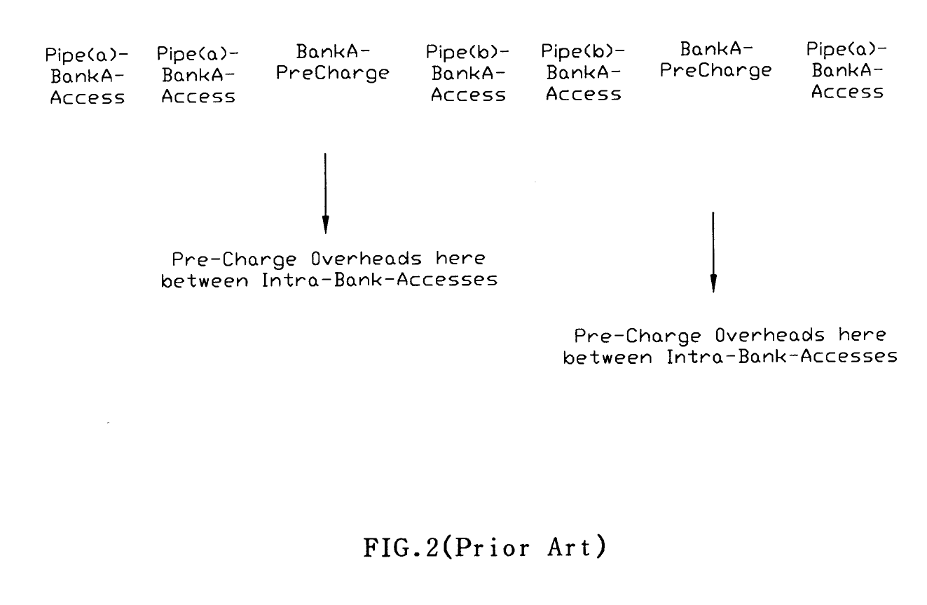

FIG. 3. Example of Sequential Mapping Method for a 2-bank SDRAM Buffer; and

FIG. 4. SDRAM Accesses Example in Interleaved Mapping Method.

### DESCRIPTION OF THE PREFERRED EMBODIMENTS

In the following, some preferred embodiments of the invention would be described in greater detail. Nevertheless, it should be recognized that the present invention could be practiced in a wider range in other embodiments beside those explicitly described, and the scope of the present invention is not limited by these expressed embodiments but specified in the accompanying claims.

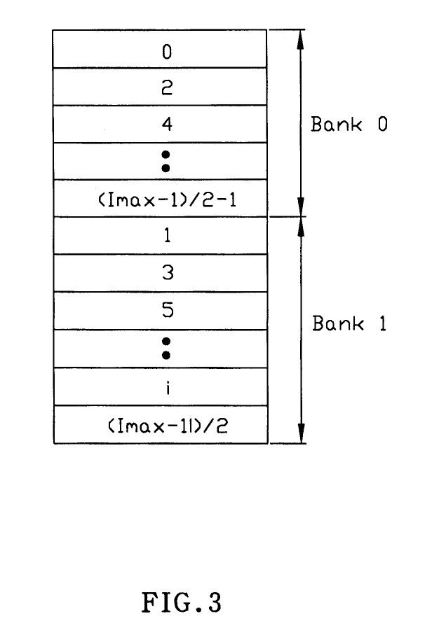

One main character of the invention is “Interleaved Mapping Method of Block-Index-to-SDRAM-Address”. As in conventional method, external SDRAM buffer is partitioned into several blocks in unit of the same size to fit a CD/DVD ECC block (1 sector for CD-ROM or 16 sectors for DVD-ROM). A block in a specific bank is pointed by an index i, with the next block pointing by index i+1 belonging to another bank (See FIG. 3). That is, any logical adjacent blocks should locate physically at different banks of the SDRAM.

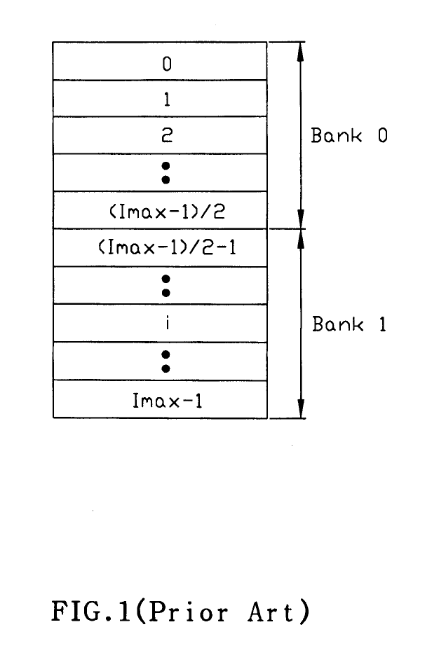

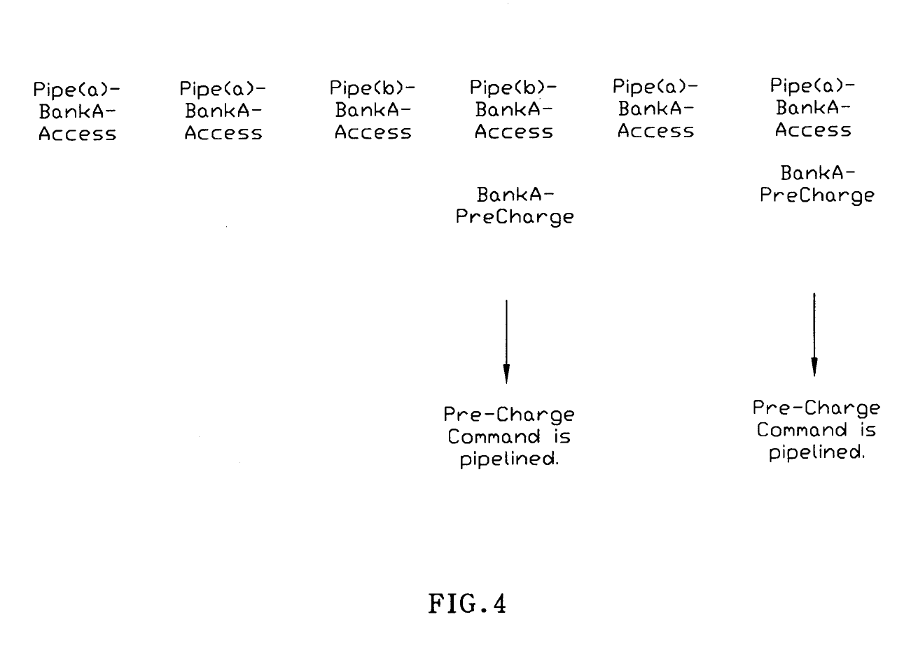

A very simple rule can be applied to map such interlaced block indices and the physical bank locations. For 2-bank SDRAM, an even index can be assigned to lower bank and an odd index assigned to higher bank. For 4-bank SDRAM, use modulo 4 to decide which bank an index should be located. With the new assignment of block index, during a constantly read command, pipeline operations of Pipe (a) and Pipe (b) tend to access the different bank of the SDRAM buffer, since in most case Pipe (a) is just one sector ahead than Pipe (b). On the other hand, during a constantly write command, pipeline operations of Pipe (a) and Pipe (b) tend to access the different bank of the SDRAM buffer, since in most case Pipe (a) is just one sector ahead of Pipe (b). Therefore, pingpong usage of inter-bank access can be frequently adopted to reduce the overheads of SDRAM access. The proposed interleave method leads to numerous inter-bank-access of Pipe (a)-Pipe (b) during a disc read or write operation and reduces pre-charge overheads between intrabank-accesses. FIG. 4 shows an SDRAM access example that overheads occurs in FIG. 1 has been removed due to pipeline operation of two different SDRAM banks. The cost is readily small that only some minor modification on SDRAM controller and some simple index-to-address mapping circuit are needed.

As the bandwidth becomes more critical for ultra-high speed CD/DVD system, this method upgrades the utilization of SDRAM buffer and offers more bandwidth to the system, without drastic design change.

The conquered problems and advantages of the invention could be briefly described as the following. For ultra-high speed (e.g. 52× CD or 16× DVD, R/RW) compact disc system, bandwidth of external memory becomes so critical that we may need to raise working frequency of SDRAM to offer more bandwidth. Or we may need to embed more internal buffer (SRAM cache) to reduce the bandwidth requirement of external SDRAM buffer. Taking advantages of pingpong usage of inter-bank SDRAM access, the proposed interleaved SDRAM address mapping method helps to transform many intra-bank-access into interbank-access so as to reduce operation cycles of SDRAM buffer and eventually offers more bandwidth to the system. Using the proposed method a theoretic value up to 10% overheads of SDRAM access can be reduced. This means 10% utilization of SDRAM bandwidth, which is lost in conventional method, is regained in the new proposed method.

Of course, it is to be understood that the present invention is not limited by these disclosed embodiments. Various modification and similar changes are still possible within the spirit of the present invention. In this way, the scope of the present invention should be defined by the appended claims.

1. A method for storing data into a SRDAM, comprising:
receiving a plurality of blocks of data;
labeling said blocks successively from 1 in step of 1;
dividing the label of each of said blocks by M and acquiring a corresponding remainder for each of said block, wherein M is the number of banks in said SRDAM and a positive integer; and
storing said blocks in said SRDAM in according to the following rule: any logical adjacent said blocks are located physically at different banks of said SRDAM.

2. The method of claim 1, wherein one said block has a remainder I is stored in the (I+1) bank in said SRDAM, I being a non-positive integer.

3. The method of claim 1, wherein a plurality of blocks in the same backs are stored in sequence.

4. The method of claim 2, wherein said blocks are arranged in the order of corresponding remainder.

5. A system for storing data into a SRDAM, comprising:
a receiver for receiving a plurality of blocks of data;
a labeler for labeling said blocks successively from 1 in step of 1;
a divider for dividing the label of each of said blocks by M and acquiring a corresponding remainder for each of said block, wherein M is the number of banks in said SRDAM and a positive integer; and
an assigner for storing said blocks in said SRDAM in according to the following rule:
any logical adjacent said blocks are located physically at different banks of said SRDAM.

6. The method of claim 5, wherein one said block has a remainder I is stored in the (I+1) bank in said SRDAM, I being a non-positive integer.

7. The method of claim 5, wherein a plurality of blocks in the same backs are stored in sequence.

8. The method of claim 6, wherein said blocks are arranged in the order of corresponding remainder.

9. A method of operating a disc player with a SRDAM, comprising:
processing a plurality of blocks of data by performing a buffer pipe, a code pipe, and a transfer pipe in a specific order, wherein the steps of storing said blocks of data into said SRDAM comprising:
labeling said blocks successively from 1 in step of 1;
dividing the label of each of said blocks by M and acquiring a corresponding remainder for each of said block, wherein M is the number of banks in said SRDAM and a positive integer; and
storing said blocks in said SRDAM in according to the following rule: any logical adjacent said blocks are located physically at different banks of said SRDAM.

10. The method of claim 9, wherein said buffer pipe is performed to receive said blocks before said code pipe is performed to decode said blocks, moreover, wherein said code pipe is performed before said transfer pipe is performed to transfer decoded block to a terminal.

11. The method of claim 10, said terminal being chosen from the group consisting of the following: laptop, table personal computer, player, display, and combination thereof.

12. The method of claim 9, wherein said code pipe is performed after said transfer pipe is performed to transfer block from a terminal, moreover, wherein said buffer pipe is performed to output said blocks before said code pipe is performed to encode said blocks.

13. The method of claim 12, said terminal being chosen from the group consisting of the following: laptop, table personal computer, player, display, and combination thereof.
